(19) United States
(12) Patent Application Publication
(10) Pub. No.: US 2023/0408792 A1
(43) Pub. Date: Dec. 21, 2023

(54) HEAD-UP DISPLAY AND MANUFACTURING METHOD FOR HEAD-UP DISPLAY

(71) Applicant: NIPPON SEIKI CO., LTD., Niigata (JP)

(72) Inventors: Bunkichi KANEKO, Niigata (JP); Takashi ONDA, Niigata (JP); Yohei SATO, Niigata (JP); Yutaka FUJITA, Niigata (JP); Akira ISOBE, Niigata (JP); Genichiro SATO, Niigata (JP)

(21) Appl. No.: 18/248,465

(22) PCT Filed: Nov. 2, 2021
(86) PCT No.: PCT/JP21/40388

§ 371 Date: Apr. 10, 2023

(30) Foreign Application Priority Data
Nov. 4, 2020 (JP) 2020-184487
Mar. 10, 2021 (JP) 2021-038451

(51) Int. Cl. G02B 7/182; G02B 27/01

(52) U.S. Cl. CPC G02B 7/182; G02B 27/0101

(57) ABSTRACT

The present invention causes a holder to hold a plane mirror without causing damage to a reflection layer. Provided is a head-up display comprising a housing, a display device that emits display light, a plane mirror that reflects the display light, and a holder that holds the plane mirror, wherein the plane mirror has a base material, and a reflection layer provided on the base material and including a resin film, and the holder abuts on a portion of the base material in which the reflection layer is not provided.

### TECHNICAL FIELD

The present disclosure relates to a head-up display and a manufacturing method for a head-up display.

### BACKGROUND ART

There is disclosed a head-up display provided with a plane mirror in front of a liquid crystal display.

### PRIOR ART DOCUMENT

### Patent Document

Patent Literature 1: JP 2013-174855 A

### SUMMARY OF THE INVENTION

### Problems to be Solved by the Invention

However, with the conventional technology described above, when the plane mirror includes a reflection layer including a resin film, it is difficult to have the plane mirror held to a holder without damaging the reflection layer.

Therefore, an object of the present disclosure is to make the holder hold the plane mirror without damaging the reflection layer.

### Solution to Problem

In one aspect, disclosed is a head-up display (1) including: a housing (2); a display device (3+6) which emits display light; a plane mirror (41) which reflects the display light; and a holder (42) which holds the plane mirror, in which the plane mirror includes a base material, and a reflection layer which is provided on the base material and includes a resin film, and the holder abuts against a portion of the base material in which the reflection layer is not provided.

### Effect of the Invention

According to the present disclosure, it is possible to make the holder hold the plane mirror without damaging the reflection layer.

### BRIEF DESCRIPTION OF THE DRAWINGS

FIG. 1A is a top perspective view of an internal configuration of a head-up display according to an embodiment.

FIG. 1B is a bottom perspective view of the head-up display.

FIG. 1C is a perspective view of a TFT panel unit.

FIG. 1D is a perspective view of a backlight unit and a heat dissipation member.

FIG. 2 is a diagram schematically illustrating the state in which a head-up display is mounted on a vehicle in a side view of the vehicle.

FIG. 3 is a perspective view of a reflecting mirror unit in a state of a single unit.

FIG. 4 is an exploded perspective view of the reflecting mirror unit.

FIG. 5 is a perspective view of a holder in a state of a single unit, as seen from a near side of an insertion direction.

FIG. 6 is an explanatory diagram of the shape of a second biasing portion.

FIG. 7 is a perspective view of a Q1 portion of FIG. 4, as seen from a different direction, in enlarged scale.

FIG. 8 is a cross-sectional view of a plane mirror according to a first embodiment.

FIG. 9 is a diagram illustrating an action of the plane mirror.

FIG. 10 is a cross-sectional view of a plane mirror according to a second embodiment.

FIG. 11 is a cross-sectional view of a plane mirror according to a third embodiment.

FIG. 12 is a cross-sectional view of a plane mirror according to a fourth embodiment.

FIG. 13 is an explanatory diagram of an angle R of a reflection layer at a Q2 portion of FIG. 4 in enlarged scale.

FIG. 14 is an explanatory diagram of a resin film formed by rolling.

FIG. 15 is a plan view showing the relationship between a reflection layer and a base material.

FIG. 16 is a perspective view showing the relationship between the reflection layer and the base material.

FIG. 17 is a plan view showing an example of a die which can be used for punching a reflection layer.

FIG. 18 is a schematic cross-sectional view taken along line D-D of FIG. 17.

FIG. 19 is a schematic enlarged view of a Q3 portion of FIG. 17.

FIG. 20 is a perspective view of a reflecting mirror unit of another example.

FIG. 21 is an exploded perspective view of the reflecting mirror unit of another example.

FIG. 22 is a perspective view of the essential part of the reflecting mirror unit of another example.

FIG. 23 is a cross-sectional view of the essential part of the reflecting mirror unit of another example.

### MODE FOR CARRYING OUT THE INVENTION

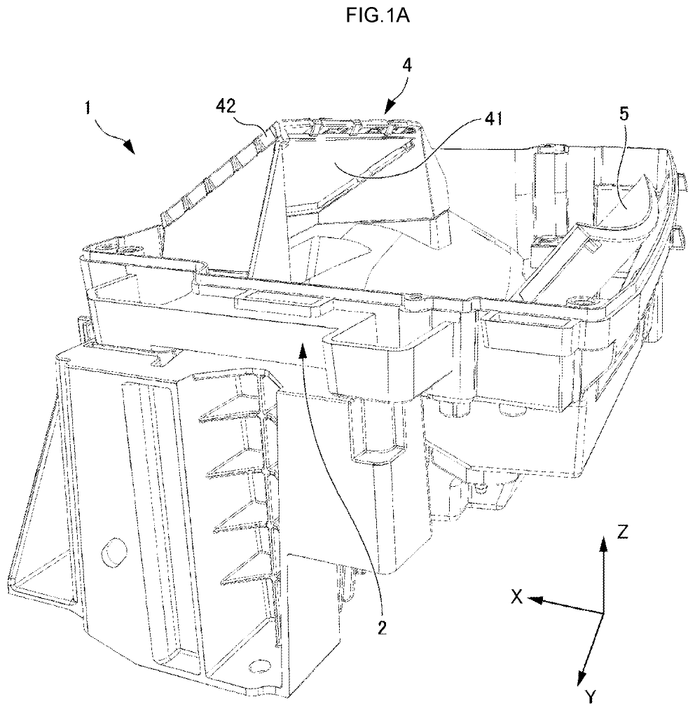

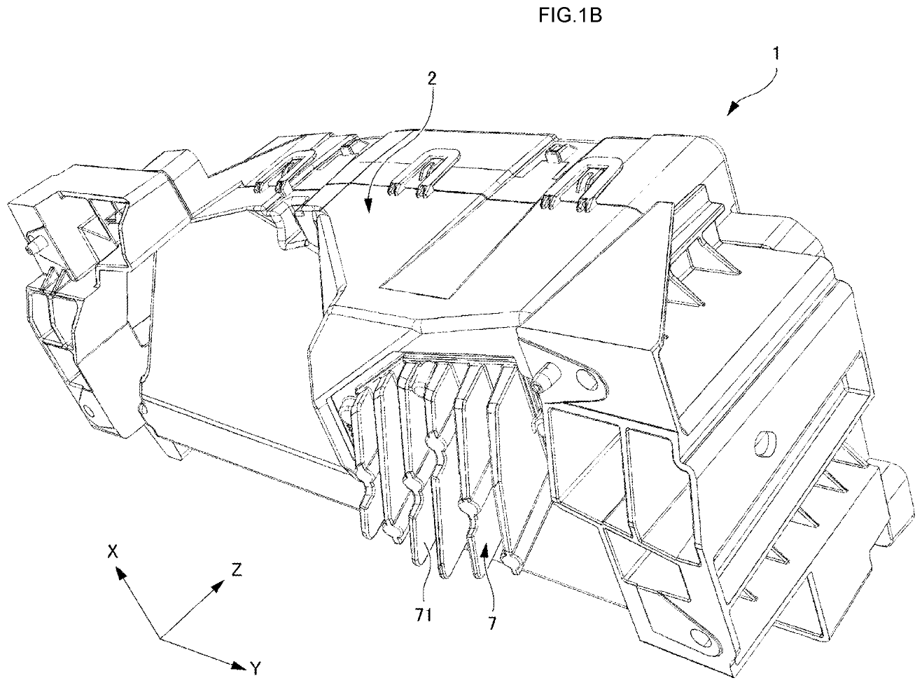

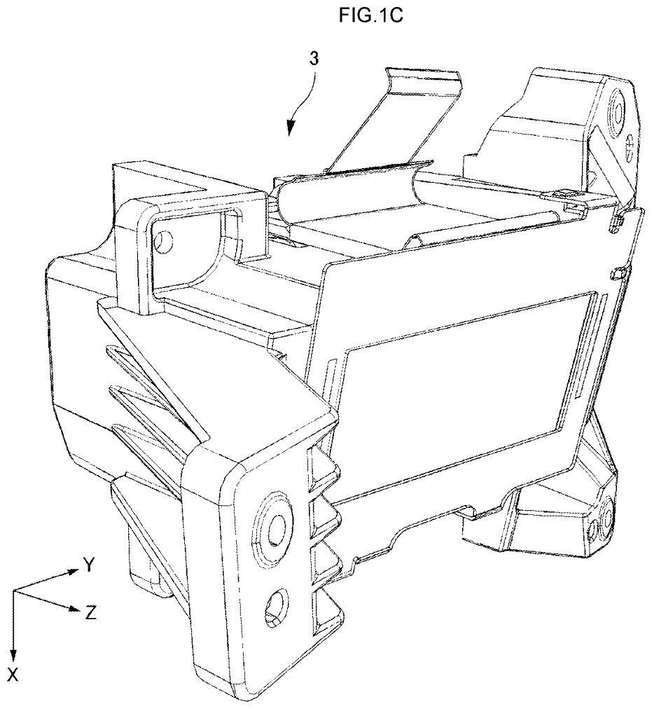

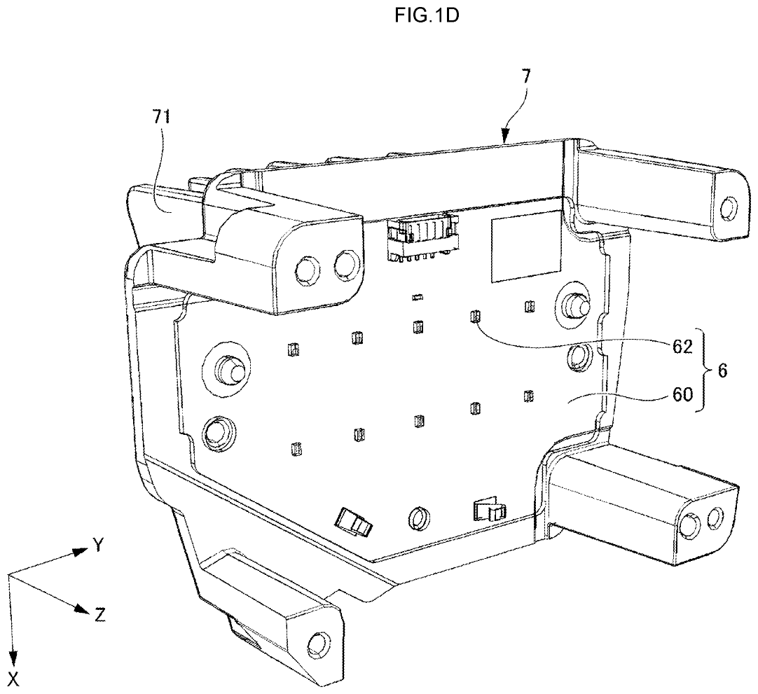

Embodiments will be described in detail below with reference to the accompanying drawings. Note that for the sake of clarity, in FIG. 1A and the like, a reference symbol may be assigned to only some of the parts or portions of the same attribute existing at a plurality of places.

Configuration of Head-Up Display

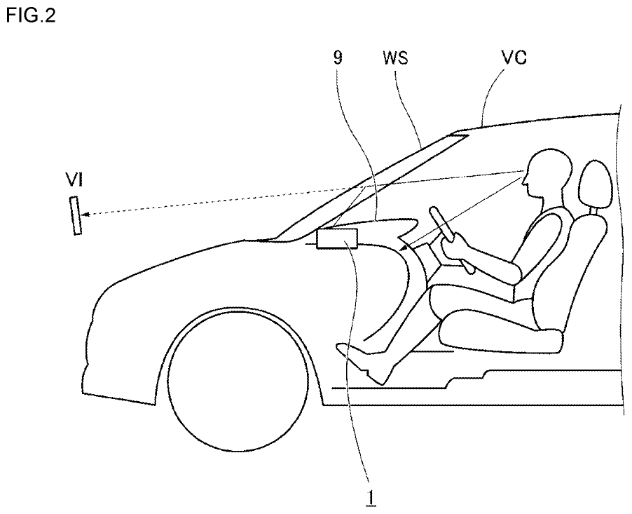

FIG. 1A is a top perspective view of an internal configuration of a head-up display 1 according to an embodiment. FIG. 1B is a bottom perspective view of the head-up display 1. FIG. 1C is a perspective view of a TFT panel unit 3. FIG. 1D is a perspective view of a backlight unit 6 and a heat dissipation member 7. FIG. 2 is a diagram schematically illustrating the state in which the head-up display 1 is mounted on a vehicle in a side view of the vehicle. In FIGS. 1A and 1B, some of constituent elements of the head-up display 1 are omitted from the illustration. In FIG. 1A and the like, three mutually orthogonal directions, that is, X direction, Y direction, and Z direction, are defined in a right-handed system. In the following, the Z direction is formally referred to as an up-down direction in which a positive side thereof is assumed as the upper side, and a negative side thereof is assumed as the lower side.

The head-up display 1 is mounted inside an instrument panel 9 of the vehicle. The head-up display 1 may be mounted in such an orientation that the Y direction in FIG. 1A substantially corresponds to a vehicle width direction.

The head-up display 1 includes a case 2, the TFT (thin-film transistor) panel unit 3, a reflecting mirror unit 4, a concave mirror 5, the backlight unit 6, and the heat dissipation member 7.

The case 2 forms a housing of the head-up display 1. The case 2 constitutes a lower case which forms the lower part of the housing of the head-up display 1. The case 2 is coupled to an upper case not shown in FIG. 1A.

The case 2 is formed of resin, for example. The case 2 may be formed by two or more members.

The TFT panel unit 3 is fixed to the case 2. The TFT panel unit 3 is a display which uses light from the backlight unit 6 as backlight to emit display light corresponding to a display image. The TFT panel unit 3 of the present embodiment is provided with a dot-matrix thin-film transistor (TFT) panel. The display image to be presented is arbitrary and may be an image representing, for example, navigation information or various kinds of vehicle information.

The reflecting mirror unit 4 is fixed to the case 2. The reflecting mirror unit 4 is provided with a plane mirror 41 and a holder 42 which holds the plane mirror 41, and reflects the display light emitted from the TFT panel unit 3 toward the concave mirror 5.

The concave mirror 5 is fixed to the case 2. The concave mirror 5 may be rotatably supported on the case 2 such that upper and lower positions of an area where the display light hits in a windshield WS is adjustable. The concave mirror 5 reflects the display light reflected by the reflecting mirror unit 4, and causes the display light to be emitted from an emission port provided in the upper case (not shown) and directed toward the windshield WS of a vehicle VC.

The backlight unit 6 is provided behind the TFT panel unit 3 (on a negative side of the Y direction). The backlight unit 6 includes, for example, a substrate 60 on which light-emitting diodes (LEDs) 62 are mounted. The substrate 60 may be placed on the heat dissipation member 7, as illustrated in FIG. 1D. The backlight unit 6 generates the display light in cooperation with the TFT panel unit 3.

The heat dissipation member 7 is formed of a material having high heat conductivity, such as aluminum. The heat dissipation member 7 is attached to the case 2 in such a way that fins 71 are exposed on the outside of the case 2. The heat dissipation member 7 has the function of dissipating heat generated by the backlight unit 6. The heat dissipation member 7 discharges the heat to the air flowing outside the case 2.

With the head-up display 1 described above, as illustrated in FIG. 2, when the windshield WS is irradiated with the display light, a driver who drives the vehicle VC can see a display image (virtual image display) VI obtained by the irradiation in front of the windshield WS. Accordingly, the driver can visually recognize the display image VI that is superimposed on the scenery ahead and ascertain vehicle information and the like with less movement in the line of sight, whereby convenience and safety are improved.

Configuration of Reflecting Mirror Unit

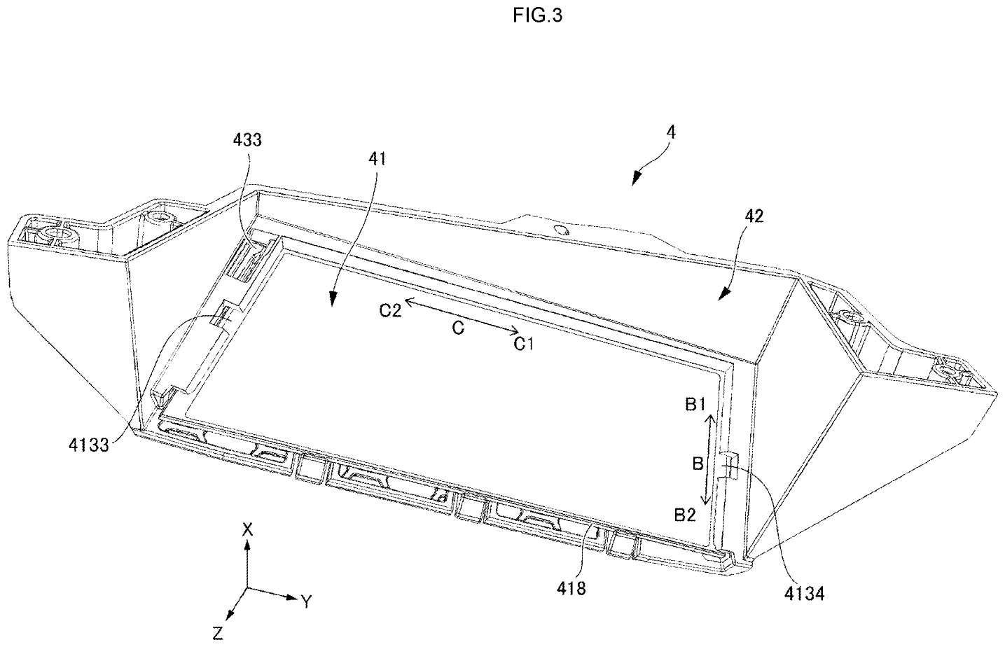

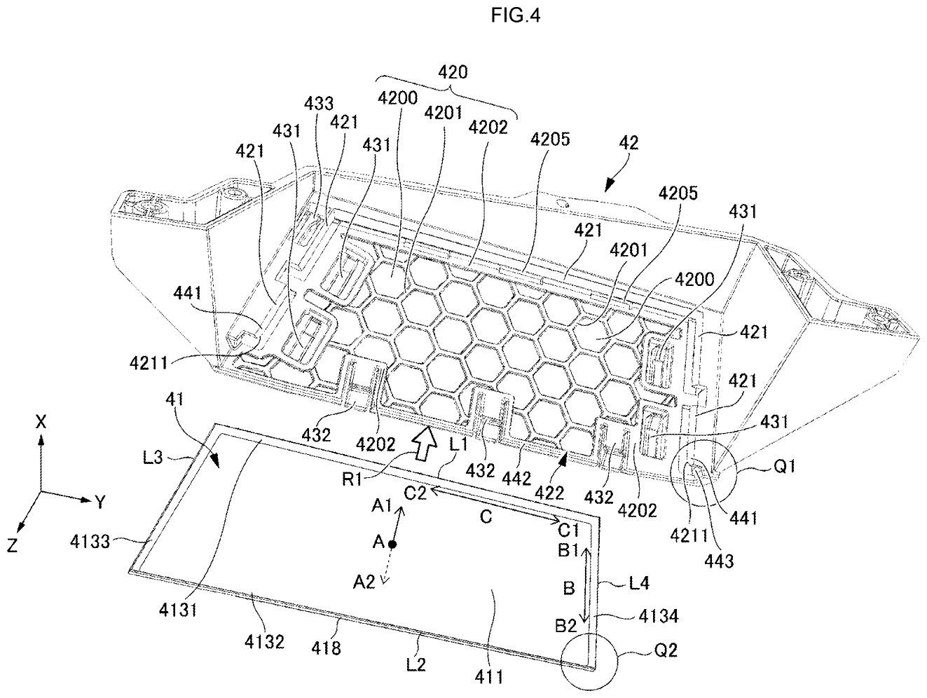

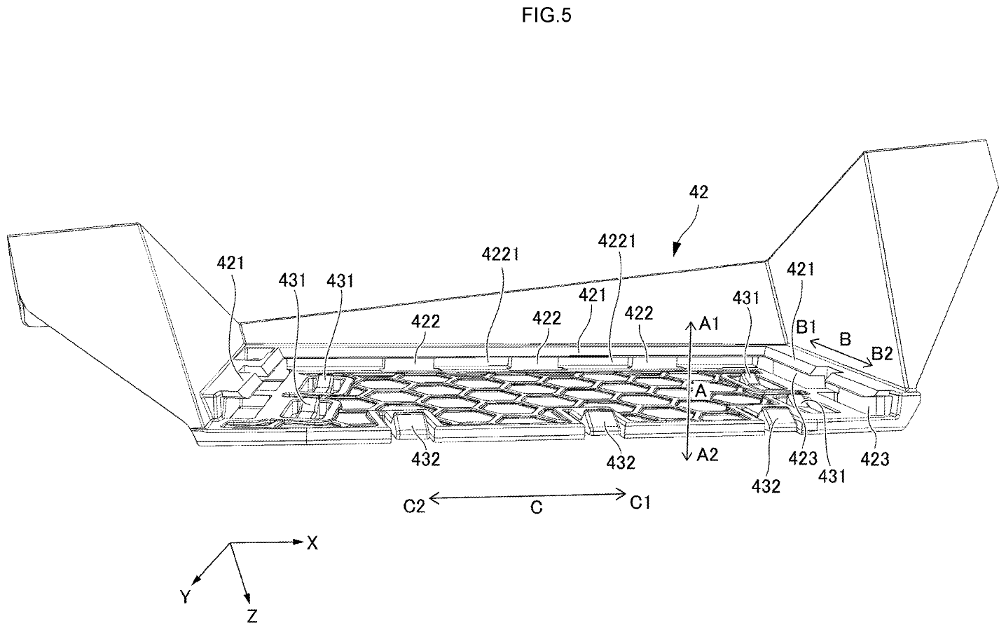

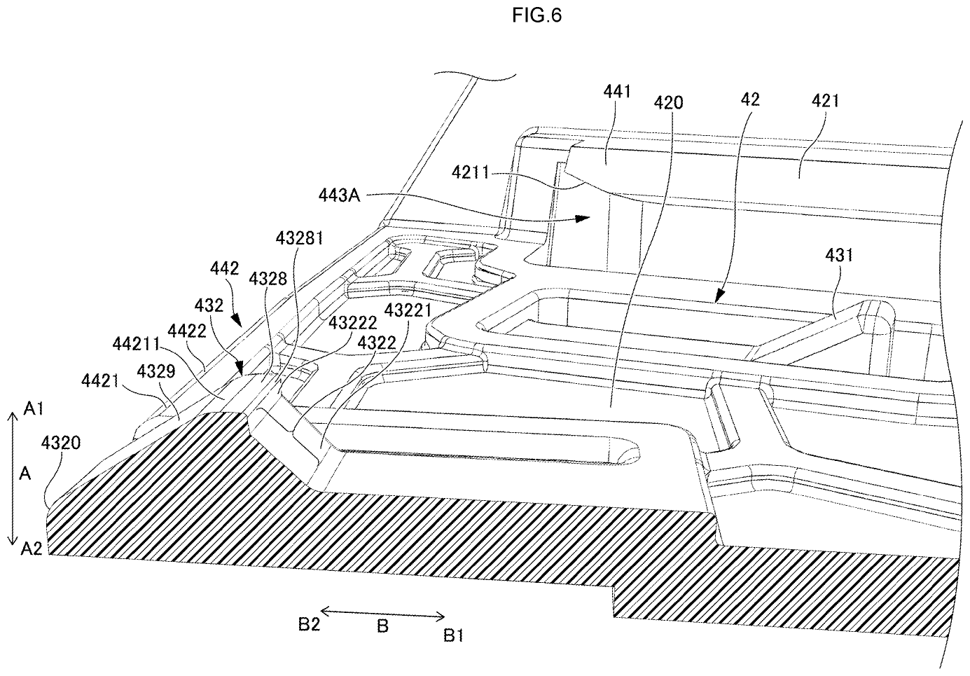

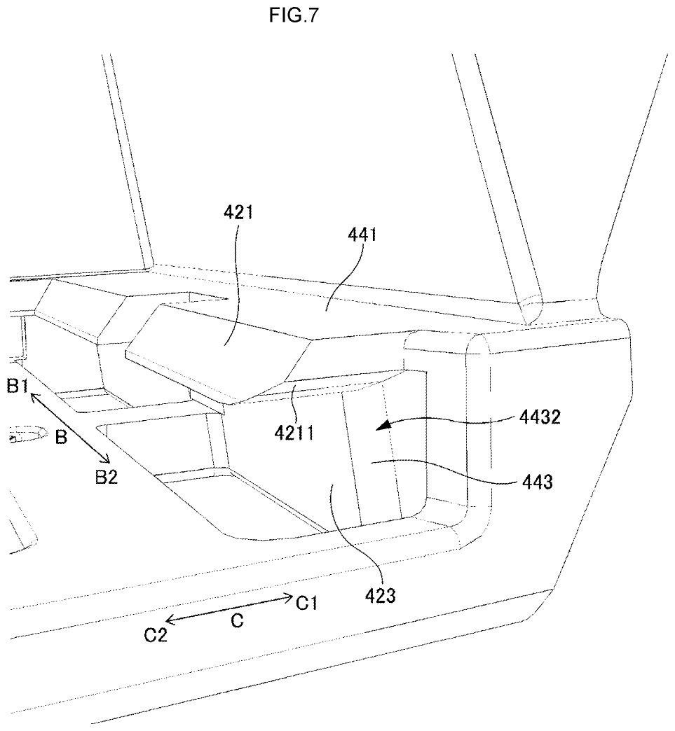

FIG. 3 is a perspective view of the reflecting mirror unit 4 in a state of a single unit, and FIG. 4 is an exploded perspective view of the reflecting mirror unit 4. FIG. 5 is a perspective view of the holder 42 in a state of a single unit, as seen from a near side of an insertion direction (refer to arrow R1 of FIG. 4). FIG. 6 is an explanatory diagram of the shape of a second biasing portion 432. FIG. 7 is an explanatory diagram of an opening on an inlet side, and is a perspective view of a Q1 portion of FIG. 4, as seen from a different direction, in enlarged scale.

In FIG. 4, A direction, B direction, and C direction are defined separately from the X direction, the Y direction, and the Z direction described above. The A direction is a direction perpendicular to a reflection surface of the plane mirror 41, and the terms “A1 side” and “A2 side” indicate a relative positional relationship with reference to a certain member. The A1 side relatively indicates the side toward the reflection surface of the plane mirror 41 from a central position of the A direction of the plane mirror 41, and the A2 side relatively indicates the side toward a rear surface of the plane mirror 41 from the central position of the A direction of the plane mirror 41. The B direction (an example of a second direction) refers to a direction orthogonal to the A direction, and corresponds to the insertion direction of the plane mirror 41 in which the plane mirror 41 is inserted into the holder 42 at the time of assembly. Also, B1 side relatively indicates the far side of the insertion direction, and B2 side relatively indicates the near side of the insertion direction. The C direction (an example of a first direction) is a direction orthogonal to both the A direction and the B direction. C1 side relatively indicates the side toward a side L4 from a central position of the C direction of the plane mirror 41, and C2 side relatively indicates the side toward a side L3 from the central position of the C direction of the plane mirror 41.

The reflecting mirror unit 4 includes the plane mirror 41 and the holder 42.

The plane mirror 41 forms the reflection surface which reflects the display light emitted from the TFT panel unit 3 toward the concave mirror 5, as described above. The plane mirror 41 has a thickness that is substantially constant, and the outer shape thereof is rectangular. In the present embodiment, as an example, the plane mirror 41 is in the form of a trapezoid in which sides L1 and L2 are parallel to each other, and the angle formed by the side L1 and the side L4 is 90 degrees, and the angle formed by the side L1 and the side L3 is greater than 90 degrees. In other words, in the plane mirror 41, the angle formed by a side surface of the side L1 side and a side surface of the side L4 side is 90 degrees, and the angle formed by a side surface of the side L1 side and a side surface of the side L3 side is greater than 90 degrees. The side surface of the side L1 side and the side surface of the side L4 side may either form the so-called pin angle or be connected to each other by a curved surface (R surface). The same applies to the side surface of the side L1 side and the side surface of the side L3 side.

The holder 42 is formed of resin, for example. The holder 42 holds the plane mirror 41. The holder 42 is fixed to the case 2. Thus, the plane mirror 41 is supported by the case 2 via the holder 42.

In the present embodiment, the holder 42 abuts against the plane mirror 41 and is elastically deformed, thereby having the function of restraining a displacement of the plane mirror 41 with respect to the holder 42 in the A direction and a displacement of the plane mirror 41 with respect to the holder 42 about an axis parallel to the A direction (for example, an axis parallel to the A direction which passes through the center of figure).

Specifically, the holder 42 includes a base portion 420, a first part 421, a second part 422, a third part 423, a first biasing portion 431, the second biasing portion 432, a third biasing portion 433, a first guide portion 441, a second guide portion 442, and a third guide portion 443.

The base portion 420 extends within an area where the plane mirror 41 overlaps the base portion 420 when viewed in the A direction. The base portion 420 is in the form of a flat surface.

Preferably, the base portion 420 should have ribs 4201 arranged in a honeycomb shape on a side opposed to the plane mirror 41 in the A direction (A1 side), as illustrated in FIG. 4. The ribs 4201 are disposed upright on a flat surface portion 4200. Consequently, in addition to reducing the thickness of the flat surface portion 4200 of the base portion 420 (and reducing the mass of the base portion 420 correspondingly), it becomes possible to increase the rigidity of the base portion 420 and also the holder 42 correspondingly. Note that the ribs 4201 may be formed in the other patterns (patterns other than the honeycombed pattern) as long as they serve the function of increasing the rigidity.

The base portion 420 further includes a frame portion 4202 whose height (height in the A direction) from the flat surface portion 4200 is slightly greater than that of the ribs 4201. The frame portion 4202 extends in the vicinity of each of the first biasing portion 431, the second biasing portion 432, and the third biasing portion 433, which will be described later, and has the function of ensuring necessary rigidity.

The base portion 420 includes a window portion 4205 penetrating in the A direction within a range in which the plane mirror 41 overlaps when viewed in the A direction. The window portion 4205 is provided so that it is possible to check the state in which the plane mirror 41 is inserted into the holder 42 in an intended way. Therefore, the window portion 4205 should preferably be provided at the far side of the insertion direction. In this case, by checking the state in which the plane mirror 41 is visible via the window portion 4205, it is possible to confirm the state in which the plane mirror 41 is inserted into the holder 42 in a desired way. In the present embodiment, as an example, three window portions 4205 are provided side by side in the C direction.

The first part 421 is separated from the base portion 420 by a distance slightly greater than the thickness of the plane mirror 41 in the A1 side of the A direction. Thus, the first part 421 extends in a range overlapping the base portion 420 when viewed in the A direction. In the present embodiment, the first part 421 is provided at a portion on both sides of the C direction in the base portion 420 and a portion on the B1 side of the B direction in the base portion 420 such that the first part 421 is opposed to each of those portions in the A direction.

The first part 421 abuts against a surface on the reflection surface side of the plane mirror 41 in the A direction at edge portions related to the three sides (the side L1, the side L3, and the side L4) of the plane mirror 41. The first part 421 has the function of restraining the displacement of the plane mirror 41 with respect to the holder 42 in the A direction, in cooperation with the first biasing portion 431 to be described later. In other words, the first part 421 abuts against the surface on the reflection surface side of the plane mirror 41 from the A1 side of the A direction, thereby restricting the displacement of the plane mirror 41 toward the A1 side of the A direction. Such a function of restraining the displacement in the A direction will be hereinafter also referred to as an “A-direction displacement restraining function”.

In the present embodiment, the first parts 421 extend in a C-shape when viewed in the A direction, as described above. Therefore, the first parts 421 can abut against the plane mirror 41 along the three sides (the side L1, the side L3, and the side L4) of the plane mirror 41. Consequently, it becomes possible to effectively enhance the A-direction displacement restraining function described above. However, in a modification example, the first part 421 may be provided in another way. For example, the first parts 421 may be provided only at the portions on the both sides of the C direction in the base portion 420 such that the first parts 421 are opposed to those portions in the A direction.

The second part 422 is disposed upright on the A1 side of the A direction at a position (a boundary position) on the far side of the insertion direction (the B1 side of the B direction) in the base portion 420, as illustrated in FIG. 5. In the present embodiment, the second part 422 does not extend continuously in the C direction, but is formed in such a way that an opening portion 4221 is formed in between.

The second part 422 abuts against the side surface, which is on the far side of the insertion direction (i.e., the side L1 side), of the plane mirror 41 in the B direction. The second part 422 has the function of restraining the displacement of the plane mirror 41 with respect to the holder 42 in the B direction, in cooperation with the second biasing portion 432 to be described later. In other words, the second part 422 abuts against the side surface on the B1 side of the B direction of the plane mirror 41 from the B1 side of the B direction, thereby restricting the displacement of the plane mirror 41 toward the B1 side of the B direction. Such a function of restraining the displacement in the B direction will be hereinafter also referred to as a “B-direction displacement restraining function”.

In the present embodiment, the second part 422 is disposed along the C direction in such a way that the second part 422 is opposed to the entire side surface of the plane mirror 41 on the B1 side of the B direction, even though the opening portion 4221 is provided in between, as described above. Thus, the B-direction displacement restraining function described above can be effectively enhanced. However, in a modification example, the second part 422 may be provided in another way.

The third part 423 is disposed upright on the A1 side of the A direction at a position (a boundary position) on the C1 side of the C direction in the base portion 420, as illustrated in FIG. 5. In the present embodiment, the third part 423 is formed in such a way that the third part 423 is contiguous with the first part 421 on the C1 side of the C direction (i.e., the way in which an L-shaped cross section is formed when viewed in the B direction), and extends in the B direction in a range that is similar to that of the first part 421 on the C1 side of the C direction.

The third part 423 abuts against the side surface, which is on the C1 side of the C direction, of the plane mirror 41 in the C direction. The third part 423 has the function of restraining the displacement of the plane mirror 41 with respect to the holder 42 in the C direction, in cooperation with the third biasing portion 433 to be described later. In other words, the third biasing portion 433 abuts against the side surface on the C1 side of the C direction of the plane mirror 41 from the C1 side of the C direction, thereby restricting the displacement of the plane mirror 41 toward the C1 side of the C direction. Such a function of restraining the displacement in the C direction will be hereinafter also referred to as a “C-direction displacement restraining function”.

In the present embodiment, the third part 423 is disposed along the B direction in such a way that the third part 423 is opposed to substantially the entire side surface of the plane mirror 41 on the C1 side of the C direction. Thus, the C-direction displacement restraining function described above can be effectively enhanced. However, in a modification example, the third part 423 may be provided in another way.

The first biasing portion 431 is provided within a range overlapping the plane mirror 41 when viewed in the A direction. In the present embodiment, as an example, two first biasing portions 431 are provided in each of ranges overlapping the plane mirror 41 on the both sides of the C direction, when viewed in the A direction, as illustrated in FIG. 4.

The first biasing portion 431 abuts against the rear surface of the plane mirror 41, and is elastically deformed mainly toward the A2 side of the A direction, thereby imparting a force in the A direction to the plane mirror 41. Specifically, the first biasing portion 431 is in the form of a claw, and in a state before the plane mirror 41 is assembled to the holder 42, a distal end portion is located more on the A1 side of the A direction as compared to the base portion 420. When the plane mirror 41 is assembled to the holder 42, the distal end portion of the first biasing portion 431 is displaced to the A2 side of the A direction, and the first biasing portion 431 is elastically deformed. As a result, the first biasing portion 431 can impart a force exerted toward the A1 side of the A direction to the plane mirror 41. As described above, a displacement of the plane mirror 41 toward the A1 side of the A direction is restricted by the first part 421. In this way, the first biasing portion 431 achieves the aforementioned A-direction displacement restraining function in cooperation with the first part 421.

In the present embodiment, the first biasing portion 431 is provided at four places such that the first biasing portions 431 act on both sides of the plane mirror 41 in the C direction and both sides of the same in the B direction, as described above. Consequently, it becomes possible to effectively enhance the A-direction displacement restraining function described above in both sides of the C direction and both sides of the B direction. However, in a modification example, the first biasing portion 431 may be provided in another way. For example, the first biasing portion 431 may additionally be provided in the vicinity of the first part 421 on the B1 side of the B direction.

The second biasing portion 432 is provided in a range overlapping the plane mirror 41 on the B2 side of the B direction, when viewed in the A direction. In the present embodiment, as an example, three second biasing portions 432 are provided side by side in the C direction, as illustrated in FIG. 4.

The second biasing portion 432 abuts against a side portion 418, which is on the near side of the insertion direction (the B2 side of the B direction), of the plane mirror 41, and is elastically deformed, thereby imparting a force in the B direction to the plane mirror 41. Specifically, as illustrated in FIG. 6, the second biasing portion 432 is in the form of a claw, and includes a return portion 4322 which engages with the side portion 418 of the plane mirror 41 on the near side of the insertion direction. When the plane mirror 41 is assembled to the holder 42, the second biasing portion 432 is displaced to the A2 side of the A direction, and the second biasing portion 432 is elastically deformed. The return portion 4322 abuts against the side portion 418, which is on the B2 side of the B direction, of the plane mirror 41 (or more precisely, a corner portion, which is on the A2 side of the A direction, of the side portion 418) in a state in which the second biasing portion 432 is elastically deformed mainly toward the A2 side of the A direction. Consequently, the second biasing portion 432 can impart a force exerted toward the B1 side of the B direction to the plane mirror 41. As described above, a displacement of the plane mirror 41 toward the B1 side of the B direction is restricted by the second part 422. In this way, the second biasing portion 432 achieves the aforementioned B-direction displacement restraining function in cooperation with the second part 422.

In the present embodiment, three second biasing portions 432 are provided side by side at substantially even intervals in the C direction, as described above. Consequently, it becomes possible to effectively enhance the B-direction displacement restraining function described above. However, in a modification example, the second biasing portion 432 may be provided in another way. For example, the middle one of the three second biasing portions 432 may be omitted. In the present embodiment, while the three second biasing portions 432 have substantially the same form as each other, parts in detail may be different.

Incidentally, in terms of achieving the B-direction displacement restraining function described above, unlike the first biasing portion 431 and the third biasing portion 433, it is necessary for the second biasing portion 432 to be located on the B2 side of the B direction with respect to the plane mirror 41. This means that when the plane mirror 41 is inserted into the holder 42 at the time of assembly, the second biasing portion 432 interferes with the plane mirror 41 prior to the first biasing portion 431 and the third biasing portion 433. Therefore, as compared to the first biasing portion 431 and the third biasing portion 433, the second biasing portion 432 more easily affects assembly performance in inserting the plane mirror 41 into the holder 42 at the time of assembly.

In this respect, as will be described below, the present embodiment has achieved a configuration of the second biasing portion 432 which can enhance the assembly performance in inserting the plane mirror 41 into the holder 42, while enhancing the B-direction displacement restraining function described above.

Specifically, referring to FIG. 6, in an edge portion 4320 of the second biasing portion 432 on the near side of the insertion direction, a distance of separation in the A direction from the rear surface of the plane mirror 41 is greater than that of an edge portion 4421 of the second guide portion 442 on the near side of the insertion direction. In other words, the edge portion 4320 of the second biasing portion 432 is located more on the A2 side of the A direction as compared to the edge portion 4421 of the second guide portion 442. Consequently, when the plane mirror 41 is inserted into the holder 42 at the time of assembly, the possibility of the plane mirror 41 interfering with the second biasing portion 432 prior to the second guide portion 442 is reduced, and the assembly performance is enhanced.

Further, the second biasing portion 432 includes, on the A1 side of the A direction, a first inclined surface 43221, a first flat surface 43222, a second flat surface 4328, and a second inclined surface 4329.

The first inclined surface 43221 is inclined in an inclination direction of gradually heading toward the A2 side of the A direction from the edge portion 4320 toward the B1 side of the B direction, when viewed in the C direction.

The first flat surface 43222 is normal to the rear surface of the plane mirror 41. The first flat surface 43222 is contiguous with the first inclined surface 43221 from the B2 side of the B direction. The first flat surface 43222 forms the return portion 4322 described above in cooperation with the first inclined surface 43221. In this case, the side portion 418, which is on the B2 side of the B direction, of the plane mirror 41 (or more precisely, the corner portion, which is on the A2 side of the A direction, of the side portion 418) abuts against the first inclined surface 43221.

In the present embodiment, the first flat surface 43222 is normal to the rear surface of the plane mirror 41. Therefore, even if the plane mirror 41 which abuts against the first inclined surface 43221 is to be displaced to the B2 side of the B direction, the first flat surface 43222 can easily have the plane mirror 41 engaged. Consequently, it becomes possible to effectively enhance the B-direction displacement restraining function described above.

The second flat surface 4328 connects with the first flat surface 43222 from the B2 side of the B direction. The second flat surface 4328 is parallel to the rear surface of the plane mirror 41. Note that the second flat surface 4328 may be connected with the first flat surface 43222 via a curved surface 43281 with a relatively small radius of curvature, as illustrated in FIG. 6. The center of curvature of the curved surface 43281 is on the A2 side. By making the radius of curvature of the curved surface 43281 relatively small, the B-direction displacement restraining function described above can be ensured.

The second inclined surface 4329 connects with the second flat surface 4328 from the B2 side of the B direction. The inclination direction of the second inclined surface 4329 is opposite to the inclination direction of the first inclined surface 43221. That is, the second inclined surface 4329 is inclined in an inclination direction of gradually heading toward the A1 side of the A direction from the edge portion 4320 toward the B1 side of the B direction, when viewed in the C direction. The degree of inclination of the second inclined surface 4329 may be smaller than that of the first inclined surface 43221. Consequently, when the plane mirror 41 is inserted into the holder 42 at the time of assembly, the plane mirror 41 is less likely to get caught on the second inclined surface 4329, and the assembly performance is enhanced.

The second inclined surface 4329 may be connected with the second flat surface 4328 via a curved surface 44211 with a relatively large radius of curvature. The center of curvature of the curved surface 44211 is on the A2 side. By making the radius of curvature of the curved surface 44211 relatively large, when the plane mirror 41 is inserted into the holder 42 at the time of assembly, the plane mirror 41 is less likely to get caught in a junction part between the second inclined surface 4329 and the second flat surface 4328, and the assembly performance is enhanced.

The third biasing portion 433 is provided at a point corresponding to the C2 side of the C direction and the B1 side of the B direction with respect to the base portion 420, as illustrated in FIGS. 3 and 4. The third biasing portion 433 abuts against the side surface of the plane mirror 41 on the C2 side of the C direction, and is elastically deformed mainly toward the C2 side of the C direction, thereby imparting a force in the C direction to the plane mirror 41. Specifically, the third biasing portion 433 is in the form of a claw, and a distal end portion thereof protrudes toward the C1 side of the C direction. When the plane mirror 41 is assembled to the holder 42, the distal end portion of the third biasing portion 433 is displaced to the C2 side of the C direction, and the third biasing portion 433 is elastically deformed. As a result, the third biasing portion 433 can impart a force exerted toward the C1 side of the C direction to the plane mirror 41. As described above, a displacement of the plane mirror 41 toward the C1 side of the C direction is restricted by the third part 423. In this way, the third biasing portion 433 achieves the aforementioned C-direction displacement restraining function in cooperation with the third part 423.

In the present embodiment, only one third biasing portion 433 is provided, but two or more third biasing portions 433 may be provided.

Here, as illustrated in FIGS. 3 and 4, in the side surface of the plane mirror 41 on the C2 side of the C direction, the third biasing portion 433 should preferably abut against the side surface on only the far side of the insertion direction (i.e., the B1 side of the B direction). Consequently, when the plane mirror 41 is inserted into the holder 42 at the time of assembly, the plane mirror 41 interferes with the third biasing portion 433 near the final stage of the insertion (and as a result of which the third biasing portion 433 is elastically deformed). Thus, as compared to the case where the plane mirror 41 interferes with the third biasing portion 433 at the initial stage of the insertion, the assembly performance is enhanced.

The first guide portion 441 is provided on the B2 side of the B direction with respect to the first part 421, as illustrated in FIG. 7. The first guide portion 441 is in the form of being contiguous with the first part 421 from the B2 side of the B direction. The first guide portion 441 functions to position, when the plane mirror 41 is inserted into the holder 42 at the time of assembly, the side portions of the plane mirror 41 on both sides of the C direction at an appropriate position in the A direction (for example, a position where the surface on the A1 side of the A direction comes into contact with the surface of the first part 421 on the A2 side of the A direction). In order to enhance such a function, the first guide portion 441 should preferably have a tapered portion 4211 configured such that the height of a space formed between the first part 421 and the base portion 420 in the A direction (i.e., a width slightly greater than the thickness of the plane mirror 41) is gradually increased in the A direction as the first guide portion 441 draws closer to the B2 side of the B direction. Although FIG. 7 illustrates only the first guide portion 441 on the C1 side of the C direction, the same applies to the first guide portion 441 on the C2 side of the C direction. However, in a modification example, one of or both of the first guide portions 441 on the C1 side and the C2 side of the C direction may be omitted.

The second guide portion 442 is provided on the B2 side of the B direction with respect to the base portion 420, as illustrated in FIG. 6. The second guide portion 442 is in the form of being contiguous with the base portion 420 from the B2 side of the B direction. The second guide portion 442 functions to position, when the plane mirror 41 is inserted into the holder 42 at the time of assembly, the rear surface of the plane mirror 41 at an appropriate position in the A direction (for example, a position where the B1 side of the B direction of the rear surface of the plane mirror 41 rides over the second inclined surface 4329 of the second biasing portion 432). In order to enhance such a function, in the second guide portion 442, preferably, a corner portion on the near side of the insertion direction should be given an angle R (see a tapered portion 4422 constituted by a curved surface), as illustrated in FIG. 6, instead of the so-called pin angle. This feature ensures the function of positioning the rear surface of the plane mirror 41 at an appropriate position in the A direction when the plane mirror 41 is inserted into the holder 42 at the time of assembly.

The third guide portion 443 is provided on the B2 side of the B direction with respect to the third part 423, as illustrated in FIG. 7. The third guide portion 443 is in the form of being contiguous with the third part 423 from the B2 side of the B direction. The third guide portion 443 functions to position, when the plane mirror 41 is inserted into the holder 42 at the time of assembly, the side portion of the plane mirror 41 in the C direction at an appropriate position in the C direction (for example, a position where the side surface of the plane mirror 41 on the C1 side of the C direction comes into contact with the surface of the third part 423 on the C2 side of the C direction). In order to enhance such a function, the third guide portion 443 should preferably realize a tapered portion 4432 configured such that the surface on the C2 side of the C direction is gradually inclined toward the C1 side of the C direction as the third guide portion 443 draws closer to the B2 side of the B direction. Although FIG. 7 illustrates the third guide portion 443 on the C1 side of the C direction, a guide portion similar to the third guide portion 443 (see a third guide portion 443A of FIG. 6) may be formed on the C2 side of the C direction.

In this way, in the present embodiment, the first guide portion 441, the second guide portion 442, and the third guide portion 443 include the tapered portions 4211, 4422, and 4432 which form, in cooperation with each other, an opening on the inlet side in inserting the plane mirror 41, and in which the opening is gradually widened toward the B2 side of the B direction, as seen in the insertion direction. Consequently, when the plane mirror 41 is inserted into the holder 42 at the time of assembly, the plane mirror 41 can be easily positioned with respect to the holder 42 in an appropriate positional relationship, and the assembly performance is improved.

Note that in a modification example, a part of or all of the first guide portion 441, the second guide portion 442, and the third guide portion 443 may be omitted, or a part of or all of the tapered portions 4211, 4422, and 4432 may be omitted.

According to the present embodiment described above, since the first biasing portion 431, the second biasing portion 432, and the third biasing portion 433 are elastically deformed as stated above, the assembly performance in inserting the plane mirror 41 into the holder 42 at the time of assembly is enhanced. Also, according to the present embodiment, since the holder 42 is elastically deformed as described, displacements of the plane mirror 41 in three directions (the A direction, the B direction, and the C direction) with respect to the holder 42 can be restrained in a substantially rattle-free manner. In this way, according to the present embodiment, it is possible to have the plane mirror 41 held to the holder 42 in a substantially rattle-free manner and with good assembly performance.

In the embodiment described above, the first biasing portion 431 abuts against the rear surface of the plane mirror 41, but this is not necessarily the case. For example, the first biasing portion 431 may abut against the surface on the reflection surface side of the plane mirror 41 and impart a force exerted toward the A2 side of the A direction to the plane mirror 41. In this case, the first biasing portion 431 may be provided on the side corresponding to the first part 421, for example. In this case, as the rear surface of the plane mirror 41 abuts against the base portion 420, a displacement toward the A2 side of the A direction is restrained.

Further, in the embodiment described above, while the third biasing portion 433 is provided on the C2 side of the C direction, the third biasing portion 433 may be provided on the C1 side of the C direction. In this case, the third part 423 is provided on the C2 side of the C direction.

Configuration of Plane Mirror

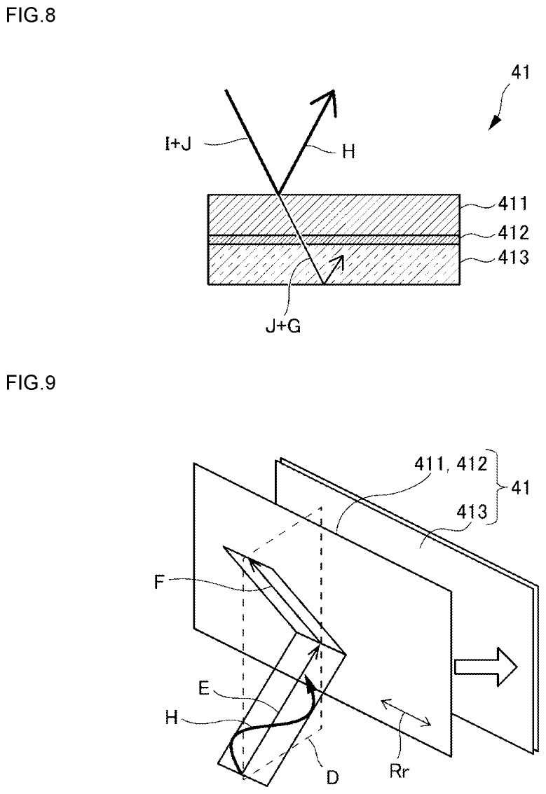

Next, a preferred configuration of the plane mirror 41 will be described with reference to FIGS. 8 and 9.

FIG. 8 is a cross-sectional view of the plane mirror 41 according to a first embodiment. FIG. 9 is a diagram illustrating an action of the plane mirror 41.

As illustrated in FIG. 8, the plane mirror 41 of the first embodiment is provided with a reflection layer 411, an adhesive layer 412, and a base material 413 to which the reflection layer 411 is bonded via the adhesive layer 412. The reflection layer 411 faces the TFT panel unit 3 and the concave mirror 5. The adhesive layer 412 and the base material 413 are disposed behind the reflection layer 411.

The reflection layer 411 is a reflective polarizing multilayer film. The reflective polarizing multilayer film is formed of several hundreds of layers of polyester resin films having different refractive indexes that are laminated on one another.

In the reflection layer 411, the refractive indexes of the respective films are adjusted such that only a specific polarization component of visible light I is reflected. The reflection layer 411 has wavelength selectivity for reflected wavelengths, and does not reflect infrared light J but allows the infrared light J to pass therethrough. The reflection layer 411 has a reflection axis and reflects a linearly polarized light component of the visible light I which is parallel to a reflection axis direction Rr. Note that the reflection axis direction Rr may be parallel to the C direction described above. The reflection layer 411 does not reflect the linearly polarized light component of the visible light I which is perpendicular to the reflection axis direction Rr but allows such a linearly polarized light component to pass therethrough. This will be specifically described with reference to FIG. 9. When the reflection axis direction Rr of the reflection layer 411 is parallel to a direction orthogonal to an incident plane D (a plane formed by incident light E and reflected light F), the reflection layer 411 allows P-polarized light G (not shown) of the visible light I, which is a wave component parallel to the incident plane D, to pass therethrough. Furthermore, the reflection layer 411 reflects S-polarized light H of the visible light I, which is a wave component orthogonal to the incident plane D.

With the plane mirror 41 provided with the reflection layer 411 as described above, the infrared light J, which is a part of external light such as sunlight incident from the outside, is passed through so as to prevent the infrared light J from reaching the TFT panel unit 3. Further, since the reflection layer 411 reflects only the S-polarized light H of the visible light I included in the external light, and allows the P-polarized light G of the same to pass therethrough, it is possible to reduce visible light which would be directed toward the TFT panel unit 3 without arranging a glass plate with a polarizing film, for example, in the vicinity of the TFT panel unit 3.

The adhesive layer 412 is made of acrylic resin and is a light transmissive adhesive layer that is colorless and transparent. The reflection layer 411 and the adhesive layer 412 are provided as an integral component, and a total thickness thereof is approximately 60 m.

The base material 413 is a member which holds the reflection layer 411 with good flatness and evenness, and satisfies both vibration resistance and transparency. Examples of the base material 413 include transparent inorganic glass. Considering economic efficiency and rigidity, inorganic glass having a thickness of 1.7 mm to 2.1 mm is applied as the plane mirror 41 of the head-up display 1.

Arrangement of Plane Mirror

The plane mirror 41 is arranged in such an orientation that the reflection axis direction Rr of the reflection layer 411 is substantially parallel to a polarization direction of the display light emitted from the TFT panel unit 3. If the plane mirror 41 is arranged in this way, display light from the TFT panel unit 3 can be reflected in a direction of a driver's viewpoint with suppressed attenuation of the display light while the visible light I directed toward the TFT panel unit 3 is reduced.

For example, the head-up display 1 of the present embodiment illustrated in FIG. 1A corresponds to the so-called lateral bend type in which the plane mirror 41 reflects the display light from the TFT panel unit 3 in a lateral direction (a direction closer to a horizontal direction than a vertical direction). Accordingly, the plane mirror 41 is arranged in such an orientation that the incident plane D pertaining to the display light from the TFT panel unit 3 is closer to a horizontal plane than to a vertical plane and that the reflection axis direction Rr of the reflection layer 411 is substantially parallel to the direction orthogonal to the incident plane D. Specifically, the plane mirror 41 is arranged in such an orientation that the reflection axis direction Rr of the reflection layer 411 conforms to a longitudinal direction (a direction closer to the vertical direction than the horizontal direction).

The angle of incidence of the display light from the TFT panel unit 3 to the plane mirror 41 should desirably be 30° to 40°. In this way, since the concave mirror 5 and the TFT panel unit 3 can be arranged at positions close to each other, the head-up display 1 can be downsized.

Other Examples of Plane Mirror

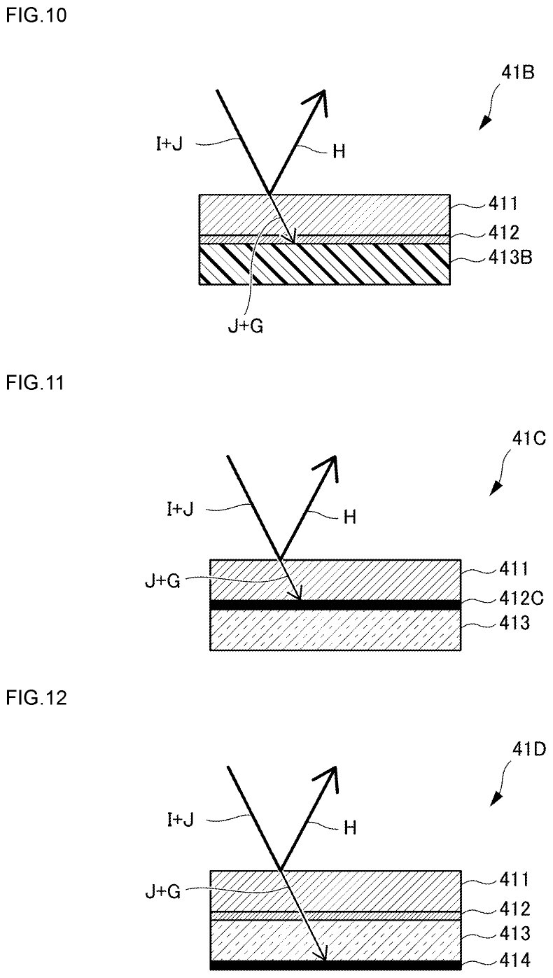

Next, plane mirrors 41B, 41C, and 41D of second to fourth embodiments will be described with reference to FIGS. 10 to 12. However, for structures in common with the first embodiment, the description of the first embodiment is referred to by using the same symbols as those of the first embodiment.

FIG. 10 is a cross-sectional view of the plane mirror 41B according to the second embodiment. FIG. 11 is a cross-sectional view of the plane mirror 41C according to the third embodiment. FIG. 12 is a cross-sectional view of the plane mirror 41D according to the fourth embodiment.

With the plane mirror 41 of the first embodiment described above, since the infrared light J and the P-polarized light G of the visible light I that are included in the external light such as sunlight are prevented from being directed toward the TFT panel unit 3, heat-shielding properties against the external light can be enhanced. However, in the plane mirror 41 of the first embodiment, as illustrated in FIG. 8, a part of the light (the infrared light J and the P-polarized light G) transmitted through the reflection layer 411 may be reflected at a rear surface of the base material 413, and transmitted through the reflection layer 411 again and directed toward the TFT panel unit 3. A rise in temperature of the TFT panel unit 3 due to such re-transmitted light may be as high as approximately 10° C. at sunlight of 1000 W/m². Further, when a holding member of the plane mirror 41 is irradiated with the light transmitted through the reflection layer 411, a molded shape of the holding member may be projected onto a display image.

As illustrated in FIG. 10, in the plane mirror 41B of the second embodiment, a base material 413B has light-shielding properties. The base material 413B having the light-shielding properties is not colorless or transparent but colored, and is composed of, for example, a black resin plate. With the plane mirror 41B described above, the light transmitted through a reflection layer 411 is absorbed by the base material 413B so that a heat-shielding effect produced by the plane mirror 41B can be enhanced. Furthermore, the base material 413B having the light-shielding properties can also prevent a molded shape of a holding member of the plane mirror 41B from being projected onto a display image.

As illustrated in FIG. 11, in the plane mirror 41C of the third embodiment, an adhesive layer 412C has light-shielding properties. The adhesive layer 412C having the light-shielding properties is not colorless or transparent but colored, and is composed of, for example, a black adhesive. With the plane mirror 41C described above, the same effect as that of the plane mirror 41B of the second embodiment may be obtained.

As illustrated in FIG. 12, the plane mirror 41D of the fourth embodiment includes a light-shielding layer 414 having light-shielding properties on a rear surface (a surface opposite to a reflection layer 411) of a base material 413. The light-shielding layer 414 is composed of a print layer, which is not colorless or transparent but is printed with a colored ink, a colored adhesive film, or the like. With the plane mirror 41D described above, the same effect as that of the plane mirror 41B of the second embodiment may be obtained. When the light-shielding layer 414 is to be configured by a print layer, a black oil-based ink or a UV-curable ink having a refractive index close to that of the base material 413 should preferably be used. Further, when the light-shielding layer 414 is to be configured by an adhesive film, a black adhesive film, which is attached via an adhesive having a refractive index close to that of the base material 413, should preferably be used. Such a configuration reduces a reflectance at a boundary surface between the base material 413 and the light-shielding layer 414, and thus the light transmitted through the reflection layer 411 can be absorbed by the light-shielding layer 414 with reliability.

Incidentally, when the plane mirror 41D of the fourth embodiment is used, as is the case with the first embodiment to the third embodiment, when the plane mirror 41D rattles against the holder 42 in such a way that the reflection axis direction Rr is deviated from a desired direction, the quality of a display image generated by the head-up display 1 is likely to deteriorate.

In this respect, since the holder 42 can hold the plane mirror 41D without rattling as described above, the possibility of such quality deterioration can be effectively reduced.

Further, when the plane mirror 41D of the fourth embodiment is used, peeling or the like may occur as the light-shielding layer 414 is pressed by the first biasing portion 431 and the second biasing portion 432 described above.

Accordingly, the light-shielding layer 414 should preferably be formed in a thickness which does not produce such peeling. For example, in forming the light-shielding layer 414 by a print layer printed with a colored ink, the light-shielding layer 414 may be realized by overlapping print layers formed by printing that has been performed at least twice. Consequently, even if the light-shielding layer 414 is pressed by the first biasing portion 431 and the second biasing portion 432 described above, the possibility of occurrence of peeling or the like in the light-shielding layer 414 can be reduced.

Here, when the plane mirror 41D of the fourth embodiment is used, as is the case with the first embodiment to the third embodiment, the same holds true for the reflection layer 411 when the plane mirror 41D is inserted into the holder 42 at the time of assembly. That is, corner portions of the reflection layer 411 (i.e., the corner portions corresponding to a corner portion of the side L1 and the side L3 of FIG. 4, a corner portion of the side L1 and the side L4, a corner portion of the side L2 and the side L3, and a corner portion of the side L2 and the side L4, respectively) may peel away.

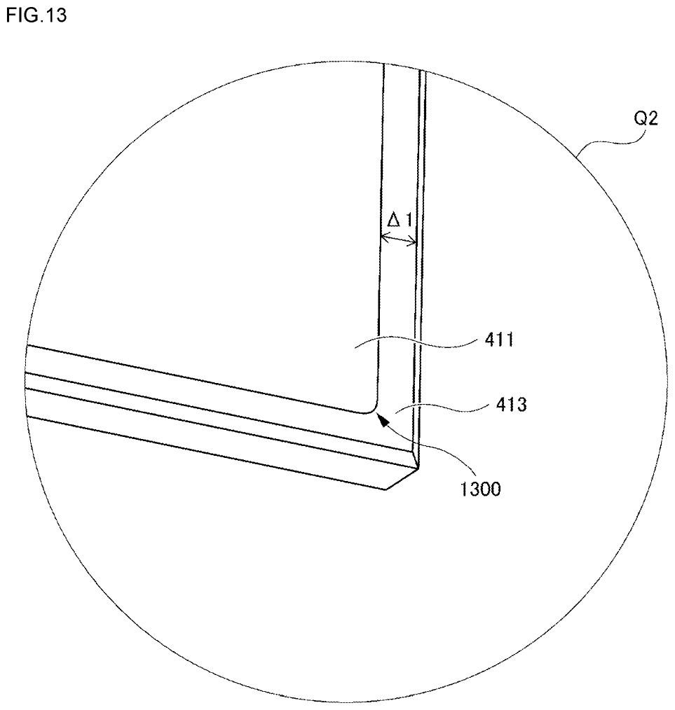

Thus, preferably, the reflection layer 411 should be given an angle R at the corner portion corresponding to each of the corner portion of the side L1 and the side L3, the corner portion of the side L1 and the side L4, the corner portion of the side L2 and the side L3, and the corner portion of the side L2 and the side L4. FIG. 13 shows, as an example, the angle R of the reflection layer 411 (see an arrow 1300) at one of the corner portions. Consequently, when the plane mirror 41D is inserted into the holder 42 at the time of assembly, even if the reflection layer 411 interferes with the holder 42, the possibility of the reflection layer 411 peeling away can be reduced. Also, in FIG. 13, an outer peripheral edge of the reflection layer 411 has a clearance A1 of approximately 0.1 to 0.5 mm from a C-face end surface of the base material 413. Consequently, the reflection layer 411 does not easily peel away from the outer peripheral edge of the reflection layer 411, and the possibility of the reflection layer 411 peeling away can be reduced. However, the clearance A1 may be set larger so that no contact (abutment) is made between the holder 42 and the reflection layer 411, as will be described later.

Relationship Between Reflection Layer and Holder, Etc.

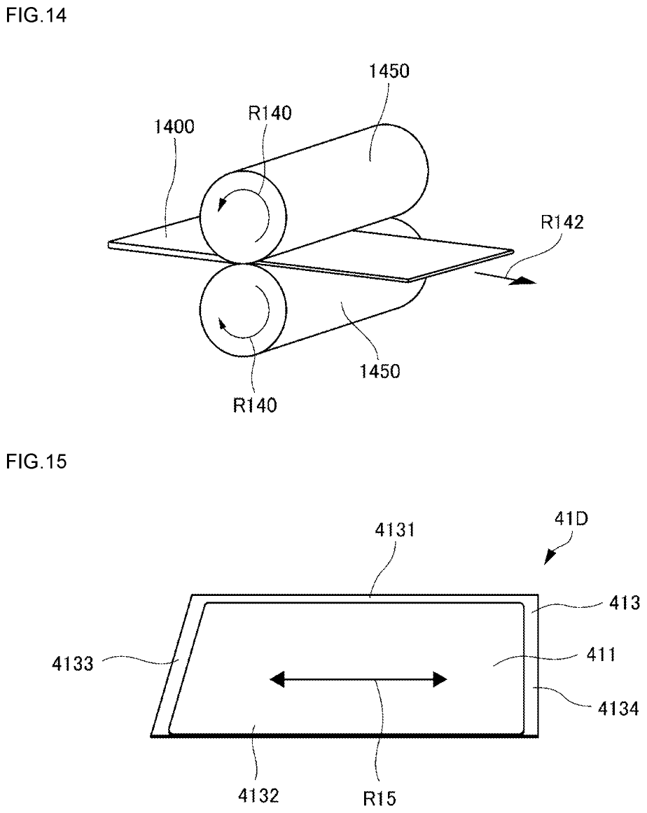

Next, with reference to FIG. 14 and the subsequent drawings, a preferred embodiment regarding a relationship between the reflection layer 411 of the plane mirror 41D according to Embodiment 4 described above and the holder 42 will be described. The following embodiment is described with respect to the plane mirror 41D according to the above-described Embodiment 4, but the description similarly applies to the plane mirrors 41, 41B, and 41C according to the first embodiment to the third embodiment described above.

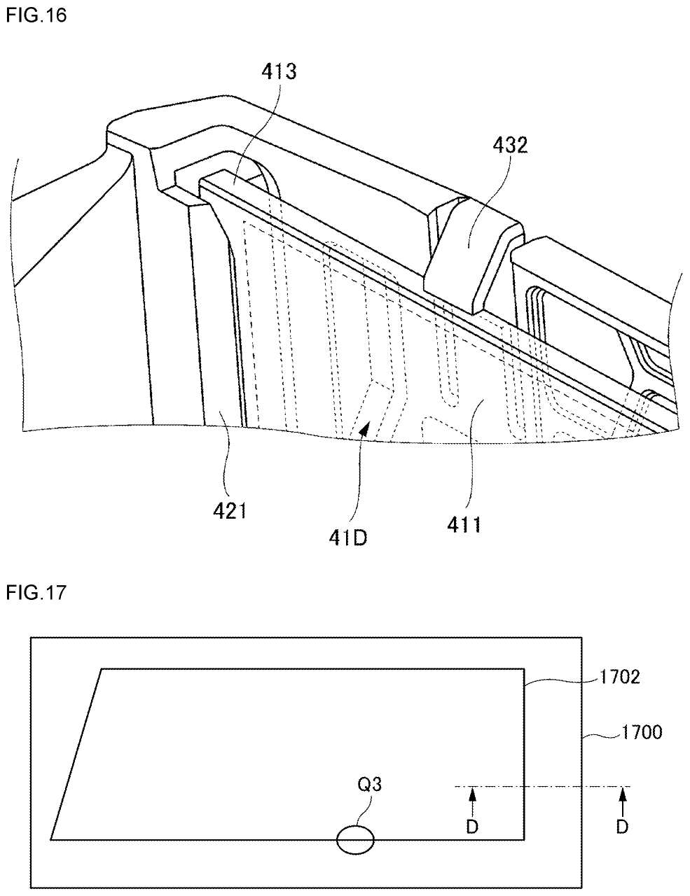

FIG. 14 is an explanatory diagram which schematically illustrates the way in which a resin film, which forms the reflection layer 411, is subjected to rolling. FIG. 15 is a plan view showing the relationship between the reflection layer 411 and the base material 413. FIG. 16 is a perspective view showing the relationship between the reflection layer 411 and the base material 413. In FIG. 16, the reflection layer 411 is indicated by a dotted line for convenience.

Incidentally, a reflective polarizing multilayer film, which is a resin film forming the reflection layer 411, is formed by subjecting a material 1400 to rolling (see an arrow R142) by a nip between rotating rolls 1450 (see an arrow R140), as illustrated in FIG. 14. In this case, the material subjected to rolling may either be a material after multilayering or a material before multilayering.

Such a resin film is likely to have the following disadvantage in a high-temperature environment. For example, if a stress is produced in the reflection layer 411, reflectance properties of the reflection layer 411 may be distorted and the intended reflectance properties may not be obtained. Specifically, the reflected light at a stressed place tends to appear iridescent and not white. If cracks (crevices) are formed in the reflection layer 411 due to a stress or the like, the cracked place may lose the function as a reflecting mirror.

Since a linear expansion coefficient of the reflection layer 411 made of resin is greater than that of the base material 413 made of inorganic glass (i.e., the reflection layer 411 expands more than the base material 413 at high temperature), the disadvantage as described above is likely to occur in a high-temperature environment.

Apart from the thermal stress described above, stresses to be produced in the reflection layer 411 may also be caused by interference (abutment or the like) of other objects, such as the holder 42, with the reflection layer 411.

Therefore, when the holder 42 is made to hold the plane mirror 41D as described above, if the holder 42 abuts against the reflection layer 411, the reflection layer 411 may be damaged and cracks may be formed in the reflection layer 411.

Therefore, the holder 42 should preferably abut against a portion of the base material 413 in which the reflection layer 411 is not provided.

Specifically, in the present embodiment, in edge portions 4131, 4132, 4133, and 4134 related to the four sides of the base material 413, the reflection layer 411 is provided on the inner side relative to the edge portions 4131, 4133, and 4134 that are related to the three sides (the side L1, the side L3, and the side L4) of the plane mirror 41D, as illustrated in FIG. 15. In other words, the reflection layer 411 is provided on the base material 413 in such a way that the reflection layer 411 does not extend to the edge portions related to the three sides (the side L1, the side L3, and the side L4) of the plane mirror 41D.

Here, as described above, the first part 421 of the holder 42 abuts against the surface on the reflection surface side of the plane mirror 41D in the A direction at the edge portions 4131, 4133, and 4134 related to the three sides (the side L1, the side L3, and the side L4) of the plane mirror 41D.

Therefore, by forming the reflection layer 411 on the inner side relative to the edge portions 4131, 4133, and 4134 related to the three sides (the side L1, the side L3, and the side L4) of the plane mirror 41D, it is possible to prevent the first part 421 from abutting against the reflection layer 411. FIG. 16 illustrates the relationship between the first part 421 and the reflection layer 411 in a perspective view. Consequently, it is possible to reduce the possibility of cracks or the like being formed in the reflection layer 411 due to the first part 421.

In this way, according to the present embodiment, the holder 42 can reliably hold the plane mirror 41D while reducing or preventing damage which may be caused to the reflection layer 411 due to interference with the holder 42.

In the present embodiment, the plane mirror 41D is inserted into the holder 42 in such an orientation that a rolling direction of the resin film related to the reflection layer 411 intersects the insertion direction (the B direction) of the plane mirror 41D with respect to the holder 42 at the time of assembly. In other words, the reflection layer 411 is formed on the base material 413 such that the rolling direction corresponds to the C direction.

Incidentally, cracks which may be formed in the reflection layer 411 tend to propagate in the direction along the rolling direction of the reflection layer 411 (the C direction indicated in FIG. 4, see an arrow R15 in FIG. 15). Therefore, if a crack is formed on either side of both ends of the reflection layer 411 in the rolling direction, the crack may spread to the other side along the rolling direction.

In this respect, in the present embodiment, of the first parts 421 that abut against the three sides (the side L1, the side L3, and the side L4) of the plane mirror 41D, the first parts 421 that abut against the side L3 and the side L4 extend in a direction orthogonal to the rolling direction of the resin film related to the reflection layer 411. Therefore, by achieving a configuration in which such first parts 421 do not abut against the reflection layer 411, it is possible to effectively reduce the possibility of undesirable cracks or the like being formed in the reflection layer 411 due to the first part 421.

In the present embodiment, the reflection layer 411 is formed on the inner side relative to the edge portions 4131, 4133, and 4134 related to the three sides (the side L1, the side L3, and the side L4) of the plane mirror 41D such that the reflection layer 411 does not abut against each of the first parts 421 that are brought in abutment with the three sides (the side L1, the side L3, and the side L4) of the plane mirror 41D. However, the reflection layer 411 is not necessarily formed in this way. For example, although the reflection layer 411 is formed on the inner side relative to the edge portions 4133 and 4134 (i.e., an example of a first edge portion) related to the two sides (the side L3 and the side L4) of the plane mirror 41D, as regards the edge portion 4131 (i.e., an example of a second edge portion) related to the side L1, the reflection layer 411 may be formed in such a way that it extends to a point (for example, the C-face end surface of the base material 413 or in the vicinity thereof) on the outer side of the edge portion 4131. Also, as for the edge portion 4132 (i.e., an example of the second edge portion) related to the side L2, which is the other one side, the reflection layer 411 is formed in such a way that it extends to the C-face end surface of the base material 413 or in the vicinity thereof. However, as in the edge portions 4131, 4133, and 4134 related to the three sides (the side L1, the side L3, and the side L4), the reflection layer 411 may be formed on the inner side relative to the edge portion 4132 related to the side L2 mentioned above.

Here, as described above, the resin film related to the reflection layer 411 is formed by subjecting the material 1400 to rolling, and thereafter, punching the material 1400 into a predetermined shape (in the present example, in the form of a trapezoid with the sides L1 and L2 being parallel to each other) by using a punching die with a cutting blade. The punching die may be a Thomson die or the like which creates a difference in level at a joint of the blade or a Pinnacle (registered trademark) die or the like in which no difference in level is formed.

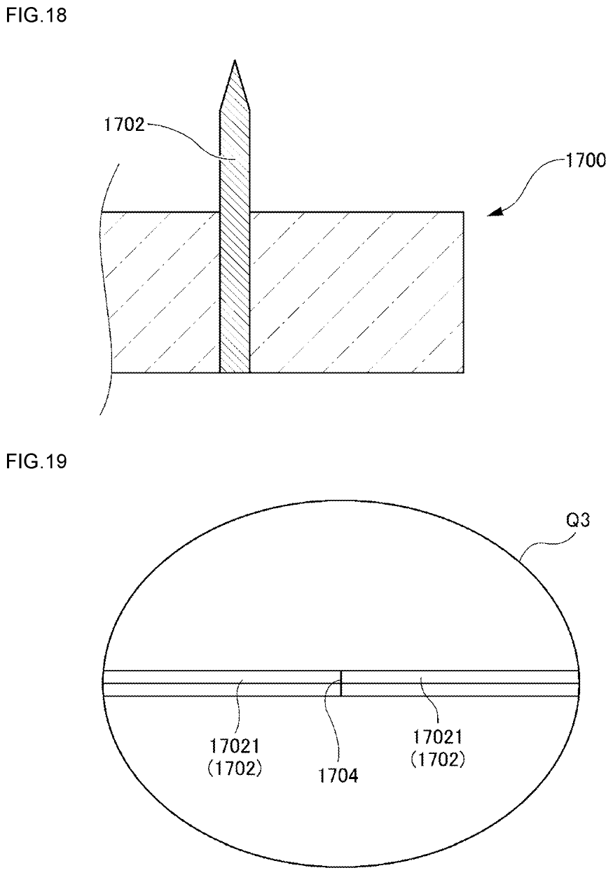

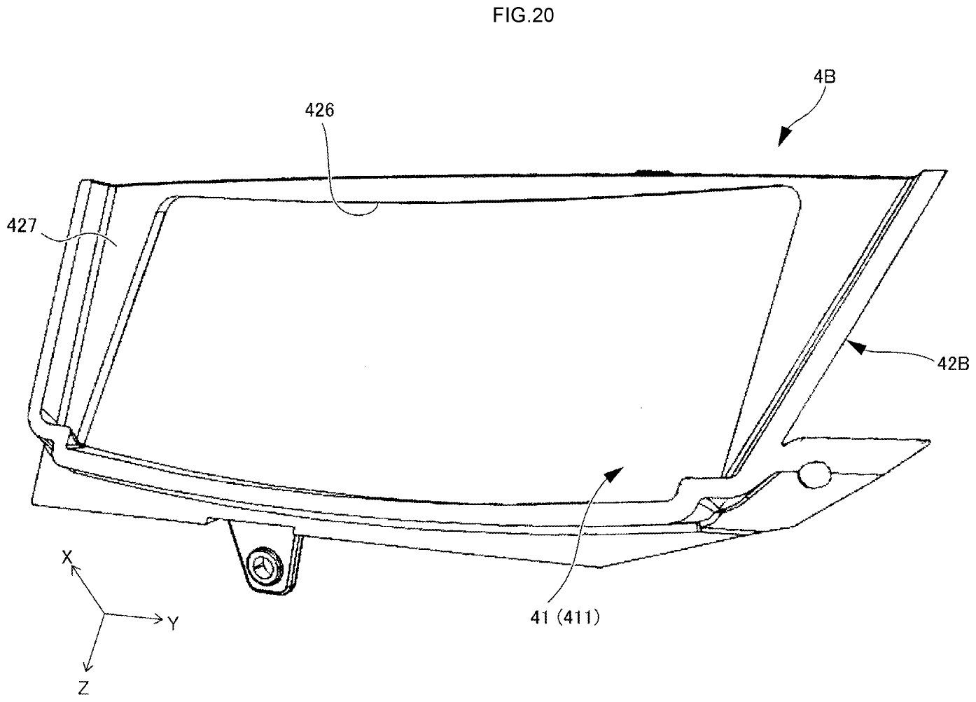

FIG. 17 is a plan view which illustrates an example of the punching die, and shows an example of a die 1700 which can be used for punching the reflection layer 411. FIG. 18 is a cross-sectional view taken along line D-D of FIG. 17. FIG. 19 is a schematic enlarged view of a Q3 portion of FIG. 17.

The die 1700 illustrated in FIGS. 17 and 18 is a Thomson die and includes a joint 1704 of a cutting blade 1702, as illustrated in FIG. 19. In other words, the cutting blade 1702 is formed by butting both end portions 17021 together such that the cutting blade 1702 extends along the outer shape of a predetermined shape (in the present example, in the form of a trapezoid with the sides L1 and L2 being parallel to each other) which is made to conform to the outer shape of the reflection layer 411. The joint 1704 between such both end portions 17021 can produce a microscopic cutout caused by a joint on an end face (a cut surface) of the resin film that has been cut. When a microscopic cutout is produced, cracks are likely to be formed as force is concentrated on the cutout.

As described above, when a resin film is to be punched into a predetermined shape by the cutting blade 1702 with the joint 1704, cracks are likely to be formed at a position corresponding to the joint of the cutting blade 1702 in an outer peripheral edge of the resin film. Further, if a microscopic cutout is produced on the sides (L3 and L4) intersecting the rolling direction (C direction in FIG. 4) of the resin film forming the reflection layer 411, cracks are formed as force is concentrated on the cutout, and the cracks are easily spread along the rolling direction.

Therefore, in the resin film which forms the reflection layer 411, preferably, the side L1 or the side L2 should be cut by a straight line part where the joint (i.e., the both end portions that are joined together) of the cutting blade 1702 is located. This feature can reduce the possibility of cracks or the like being formed in the resin film as compared to the case where the side L3 or the side L4 is cut by the straight line part where the joint of the cutting blade 1702 is located.

Other Examples of Reflecting Mirror Unit Next, a reflecting mirror unit 4B of another example will be described with reference to FIGS. 20 to 23. However, for structures in common with the above-described embodiment, the description of the above-described embodiment is referred to by using the same symbols as those of the above-described embodiment.

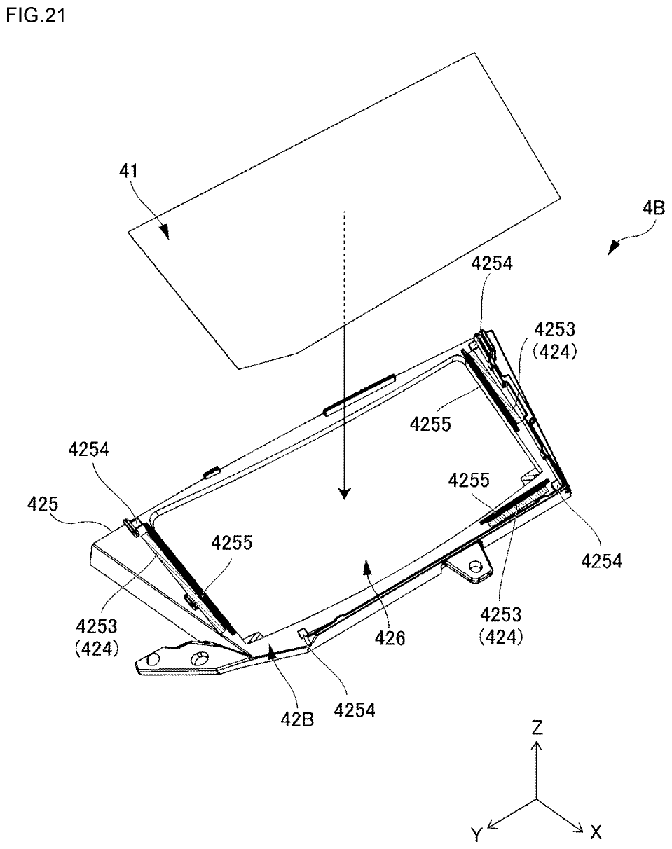

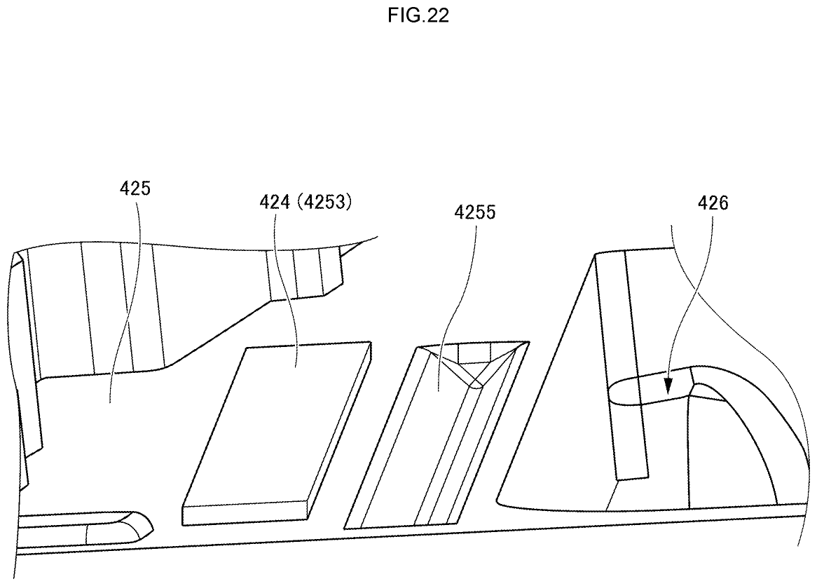

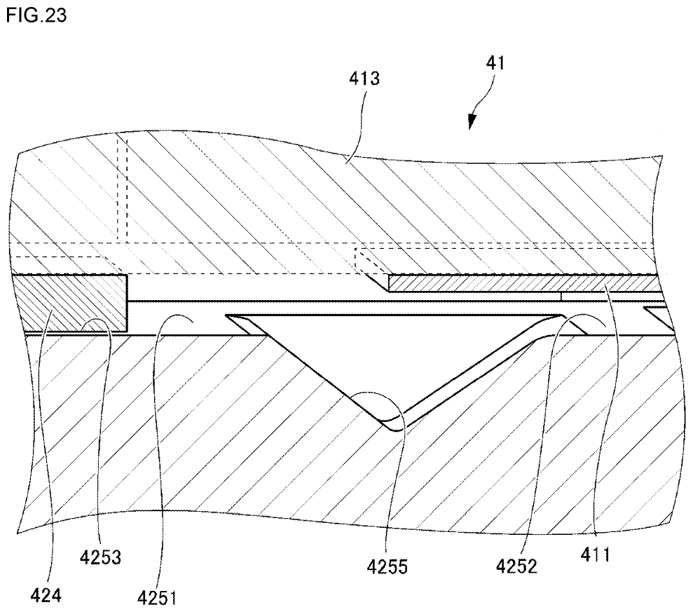

FIG. 20 is a perspective view of the reflecting mirror unit 4B of another example. FIG. 21 is an exploded perspective view of the reflecting mirror unit 4B of another example. FIG. 22 is a perspective view of the essential part of the reflecting mirror unit 4B of another example. FIG. 23 is a cross-sectional view of the essential part of the reflecting mirror unit 4B of another example.

As illustrated in FIG. 21, the reflecting mirror unit 4B of another example is different from the above-described embodiment in that the plane mirror 41 is fixed to a holder 42B by means of an adhesive 424. The adhesive 424 is in the form of a liquid at least when applied, and a hot-melt adhesive, for example, is used.

As illustrated in FIGS. 20 and 21, the holder 42B of another example includes a first surface 425 to which the plane mirror 41 is bonded and a second surface 427 which exposes the reflection layer 411 of the plane mirror 41 through an opening portion 426.

As illustrated in FIGS. 21 to 23, the first surface 425 of the holder 42B includes: a first opposed portion 4251 which is opposed to a portion of the base material 413 of the plane mirror 41 in which the reflection layer 411 is not provided; a second opposed portion 4252 which is opposed to the reflection layer 411 of the plane mirror 41; a plurality of adhesive portions 4253 to which the plane mirror 41 is fixed via the adhesive 424; a plurality of abutment portions 4254 which define the thickness of the adhesive 424; and a plurality of grooves 4255 which accommodate an excess adhesive.

The adhesive portion 4253 is provided in the first opposed portion 4251, and the portion of the base material 413 of the plane mirror 41 in which the reflection layer 411 is not provided is fixed to the adhesive portion 4253 via the adhesive 424. In the example illustrated in FIG. 21, the adhesive portion 4253 is provided at three places on the first surface 425 so as to extend along end edge portions of the opening portion 426, and the three sides of the plane mirror 41 are fixed to the adhesive portions 4253 via the adhesive 424.

The abutment portion 4254 is provided to protrude at the first opposed portion 4251, and as the abutment portion 4254 abuts against the portion of the base material 413 of the plane mirror 41 in which the reflection layer 411 is not provided, a distance between the base material 413 of the plane mirror 41 and the adhesive portion 4253, in other words, the thickness of the adhesive 424 is defined. In the example illustrated in FIG. 21, the abutment portion 4254 having a quadrangular flat surface as an abutment surface is provided to protrude at four corners of the first surface 425. Although an area of abutment and a length of abutment against the plane mirror 41 of the abutment portion 4254 illustrated in FIG. 21 are comparatively small, the number of abutment portions 4254, the area of abutment, and the length of abutment can be changed as appropriate as long as the abutment portion 4254 can define the thickness of the adhesive 424.

The groove 4255 is provided between the adhesive portion 4253 and the opening portion 426 such that the groove 4255 is parallel to the adhesive portion 4253. The length of the groove 4255 is substantially the same as or greater than that of the adhesive portion 4253. With such a groove 4255, an excess adhesive, which has been pressed between the adhesive portion 4253 and the plane mirror 41 and has flowed toward the opening portion 426 during an adhesion step of the plane mirror 41, is accommodated. Thus, it is possible to prevent the excess adhesive from flowing out into the opening portion 426, which is the reflective area of the plane mirror 41.

A cross-sectional shape of the groove 4255 should desirably be in the form of a V-groove. When a cross-sectional shape of the groove 4255 is in the form of a quadrangular groove, it is difficult for an excess adhesive to flow into the groove 4255 due to the surface tension. In contrast, the groove 4255 in the form of a V-groove can suppress the surface tension and promote an inflow of the excess adhesive.

As illustrated in FIG. 23, the reflection layer 411 of the plane mirror 41 is held in such a state of being floated from the second opposed portion 4252 by a predetermined dimension since abutment of the reflection layer 411 against the second opposed portion 4252 can be a cause of cracks. However, the dimension is very small, and thus the excess adhesive may adhere and cause cracks. The groove 4255 is located between the adhesive portion 4253 and the second opposed portion 4252, as illustrated in FIG. 23, and can accommodate the excess adhesive in front of the reflection layer 411 and prevent the excess adhesive from adhering to the reflection layer 411.

In this case, the groove 4255 should ideally be provided between the adhesive portion 4253 and the second opposed portion 4252 so that the groove 4255 does not overlap the reflection layer 411. However, as illustrated in FIG. 23, when the groove 4255 overlaps the reflection layer 411, it is desirable that the groove 4255 be provided in such a way that the center position of the groove width is closer to the adhesive portion 4253 than from an end face of the reflection layer 411. By doing so, it is possible to increase a distance between the end face of the reflection layer 411 and a groove bottom of the groove 4255, and prevent adhesion of the excess adhesive to the reflection layer 411.

Although the embodiments have been described in detail above, the present embodiment is not limited to a specific embodiment, and various modifications and changes may be made within the scope of the claims. Furthermore, all of or some of the constituent elements of the embodiments described above may be combined.

### DESCRIPTION OF REFERENCE NUMERALS

1 Head-up display
2 Case
3 TFT panel unit
4 Reflecting mirror unit
5 Concave mirror
6 Backlight unit
7 Heat dissipation member
71 Fin
9 Instrument panel
41 Plane mirror
41B Plane mirror
41C Plane mirror
41D Plane mirror
42 Holder
411 Reflection layer
412 Adhesive layer
412C Adhesive layer
413 Base material
413B Base material
414 Light-shielding layer
418 Side portion
420 Base portion
421 First part
422 Second part
423 Third part
431 First biasing portion
432 Second biasing portion
433 Third biasing portion
441 First guide portion
442 Second guide portion
443 Third guide portion
443A Third guide portion
4200 Flat surface portion
4201 Rib
4202 Frame portion
4205 Window portion
4211 Tapered portion
4221 Opening portion
4320 Edge portion
4322 Return portion
4328 Second flat surface
4329 Second inclined surface
4421 Edge portion
4422 Tapered portion
4432 Tapered portion
43221 First inclined surface
43222 First flat surface
43281 Curved surface
44211 Curved surface
4B Reflecting mirror unit
42B Holder
424 Adhesive
425 First surface
4251 First opposed portion
4252 Second opposed portion
4253 Adhesive portion
4254 Abutment portion
4255 Groove
426 Opening portion
427 Second surface

1. A head-up display comprising:
a housing;
a display device which emits display light;
a plane mirror which reflects the display light; and
a holder which holds the plane mirror, wherein
the plane mirror includes a base material, and a reflection layer which is provided on the base material and includes a resin film, and
the holder abuts against a portion of the base material in which the reflection layer is not provided.

2. The head-up display according to claim 1, wherein:
the base material includes a first edge portion on both sides of a first direction along a rolling direction of the resin film, and a second edge portion on both sides of a second direction intersecting the first direction;
the reflection layer is provided on an inner side relative to the first edge portion of the base material; and
the holder abuts against the first edge portion.

3. A manufacturing method for a head-up display, the manufacturing method comprising:
preparing a resin film by employing a cutting blade, which is formed by butting both end portions together such that the cutting blade extends along an outer shape of a predetermined shape, and cutting, by the cutting blade, a resin film material formed by rolling into the predetermined shape;
providing a reflection layer including the resin film on a base material; and
inserting a plane mirror including the base material provided with the reflection layer into a holder of the head-up display, and having the plane mirror held to the holder, wherein
the cutting blade includes the both end portions on a side, which is along a rolling direction of the resin film, of the predetermined shape.

4. The manufacturing method for the head-up display according to claim 3, wherein the plane mirror is inserted into the holder in an insertion direction which intersects the rolling direction of the resin film.

5. The head-up display according to claim 1, wherein the holder comprises an adhesive portion, to which a portion of the base material in which the reflection layer is not provided is fixed via an adhesive.

6. The head-up display according to claim 5, wherein the holder comprises:
an opposed portion which is opposed to the reflection layer; and
a groove formed between the adhesive portion and the opposed portion.

7. The head-up display according to claim 5, wherein the holder comprises:
an opening portion which exposes the reflection layer; and
a groove formed between the adhesive portion and the opening portion.

8. The head-up display according to claim 5, wherein:
the holder comprises an abutment portion which abuts against a portion of the base material in which the reflection layer is not provided; and
the abutment portion defines a thickness of the adhesive to be applied to the adhesive portion.
